(19) United States
(12) Patent Application Publication
(10) Pub. No.: US 2010/0025250 A1
(43) Pub. Date: Feb. 4, 2010

(54) Droplet Actuator Structures

(75) Inventors: Vamsee K. Pamula, Durham, NC (US); Michael G. Pollack, Durham, NC (US); Vijay Srinivasan, Durham, NC (US); Philip Paik, San Diego, CA (US)

Correspondence Address: ADVANCED LIQUID LOGIC, INC.;C/O WARD AND SMITH, P.A., 1001 COLLEGE COURT, P.O. BOX 867, NEW BERN, NC, 28563-0867, US

(73) Assignee: ADVANCED LIQUID LOGIC, INC., Research Triangle Park, NC (US)

(21) Appl. No.: 12/529,041

(22) PCT Filed: Mar. 3, 2008
(86) PCT No.: PCT/US08/55648

§ 371 Date: Aug. 28, 2009

Related U.S. Application Data
(60) Provisional application No. 60/892,285, filed on Mar. 1, 2007.
(60) Provisional application No. 60/895,784, filed on Mar. 20, 2007.
(60) Provisional application No. 60/980,463, filed on Oct. 17, 2007.

(51) Int. Cl. B41J 2/045; B03C 9/00

(52) U.S. Cl. 204/660

(57) ABSTRACT

The objective of this research is to model and design a microfluidic system that uses electrostatic fields to induce movement of discrete droplets of solution. Of particular interest is movement of droplets of H₂O for use in biological testing with lab-on a-chip and μTAS systems. Using computer modeling, the electric-fields for planar electrode configurations positioned on an insulating substrate are calculated for a hemispherical drop of H₂O on the substrate at various positions. From these electric-fields the force on the drop is calculated. These models show that electrostatic actuation of droplets of H₂O is possible. However, as the complexity of the model increases the properties of the system become less desirable and actuation may not be possible. Using microfabrication techniques, the modeled microfluidic systems have been built for testing using a Kapton substrate with copper electrodes. Hexadecenyltrichlorosilane (HTS), a self-assembled monolayer, and its oxidant have been studied and found capable of providing hydrophobic and hydrophilic surface coatings for the systems.

### RELATED APPLICATIONS

In addition to the patent applications cited herein, each of which is incorporated herein by reference, this patent application is related to and claims priority to U.S. Provisional Patent Application No. 60/892,285, filed on Mar. 1, 2007, entitled “Droplet actuator architectures;” U.S. Provisional Patent Application No. 60/895,784, filed on Mar. 20, 2007, entitled “Single metal layer microactuator structures;” and U.S. Provisional Patent Application No. 60/980,463, filed on Oct. 17, 2007, entitled “Droplet actuator architectures;” the entire disclosures of which are incorporated herein by reference.

### GRANT INFORMATION

This invention was made with government support under DK066956-02 awarded by the National Institutes of Health of the United States. The United States Government has certain rights in the invention.

### FIELD OF THE INVENTION

The present invention generally relates to the field of conducting droplet operations in a droplet actuator. In particular, the present invention is directed to droplet actuator structures.

### BACKGROUND OF THE INVENTION

Droplet actuators are used to conduct a wide variety of droplet operations. A droplet actuator typically includes a substrate associated with electrodes for conducting droplet operations on a droplet operations surface thereof and may also include a second substrate arranged in a generally parallel fashion in relation to the droplet operations surface to form a gap in which droplet operations are effected. The gap is typically filled with a filler fluid that is immiscible with the fluid that is to be subjected to droplet operations on the droplet actuator. Surfaces exposed to the gap are typically hydrophobic. Electrodes that are associated with one or both substrates are arranged for conducting a variety of droplet operations, such as droplet transport and droplet dispensing. There is a need for alternative approaches to configuring and wiring electrodes in a droplet actuator.

### BRIEF DESCRIPTION OF THE INVENTION

The invention provides example approaches to configuring and wiring electrodes in a droplet actuator. Droplet actuators employing the designs of the invention are useful for conducting a variety of droplet operations.

In one set of embodiments, the droplet actuator of the invention includes various single-layer wiring configurations for mitigating the constraints and drawbacks that are associated with single-layer designs, such as wireability constraints, limited mechanisms for performing droplet operations, electrostatic interference from wires, and any combinations thereof. A plurality of transport electrodes, reservoir electrodes, fluid reservoirs, and wires can be provided on a single-layer of a droplet actuator in varying arrangements. Transport electrodes may be configured to impart a gradient force to a droplet of sufficient force to manipulate the droplet. Electrostatic interference reducing structures may also be provided.

In another set of embodiments, the droplet actuator of the invention can include a reference electrode that is situated on one substrate that is separated by a gap from a second substrate and one or more control electrodes that are situated on the second substrate. The control electrodes may be placed such that the second substrate is interposed between the control electrodes and the first substrate. A substantially planar substrate may be provided comprising an anisotropic conductive element. Recessed regions may be provided wherein electrodes are arranged in the recessed regions. A dispensing electrode configuration may be provided comprising a reservoir electrode and one or more droplet dispensing electrodes.

### DEFINITIONS

As used herein, the following terms have the meanings indicated.

“Activate” with reference to one or more electrodes means effecting a change in the electrical state of the one or more electrodes which results in a droplet operation.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical and other three dimensional shapes. The bead may, for example, be capable of being transported in a droplet on a droplet actuator or otherwise configured with respect to a droplet actuator in a manner which permits a droplet on the droplet actuator to be brought into contact with the bead, on the droplet actuator and/or off the droplet actuator. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead or one component only of a bead. The remainder of the bead may include, among other things, polymeric material, coatings, and moieties which permit attachment of an assay reagent. Examples of suitable magnetically responsive beads are described in U.S. Patent Publication No. 2005-0260686, entitled, “Multiplex flow assays preferably with magnetic particles as solid phase,” published on Nov. 24, 2005, the entire disclosure of which is incorporated herein by reference for its teaching concerning magnetically responsive materials and beads. The beads may include one or more populations of biological cells adhered thereto. In some cases, the biological cells are a substantially pure population. In other cases, the biological cells include different cell populations, e.g., cell populations which interact with one another.

“Droplet” means a volume of liquid on a droplet actuator that is at least partially bounded by filler fluid. For example, a droplet may be completely surrounded by filler fluid or may be bounded by filler fluid and one or more surfaces of the droplet actuator. Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a droplet actuator.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to size of the resulting droplets (i.e., the size of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading.

“Immobilize” with respect to magnetically responsive beads, means that the beads are substantially restrained in position in a droplet or in filler fluid on a droplet actuator. For example, in one embodiment, immobilized beads are sufficiently restrained in position to permit execution of a splitting operation on a droplet, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

“Washing” with respect to washing a magnetically responsive bead means reducing the amount and/or concentration of one or more substances in contact with the magnetically responsive bead or exposed to the magnetically responsive bead from a droplet in contact with the magnetically responsive bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Other embodiments are described elsewhere herein, and still others will be immediately apparent in view of the present disclosure.

The terms “top” and “bottom” are used throughout the description with reference to the top and bottom substrates of the droplet actuator for convenience only, since the droplet actuator is functional regardless of its position in space.

When a given component, such as a layer, region or substrate, is referred to herein as being disposed or formed “on” another component, that given component can be directly on the other component or, alternatively, intervening components (for example, one or more coatings, layers, interlayers, electrodes or contacts) can also be present. It will be further understood that the terms “disposed on” and “formed on” are used interchangeably to describe how a given component is positioned or situated in relation to another component. Hence, the terms “disposed on” and “formed on” are not intended to introduce any limitations relating to particular methods of material transport, deposition, or fabrication.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### BRIEF DESCRIPTION OF THE DRAWINGS

FIG. 1 illustrates a top view of a wiring structure of a portion of a droplet actuator, which is one embodiment of a single-layer wiring structure;

FIG. 2 illustrates a top view of a wiring structure of a portion of a droplet actuator, which is another embodiment of a single-layer wiring structure;

FIG. 3 illustrates a top view of a wiring structure of a portion of a droplet actuator, which is yet another embodiment of a single-layer wiring structure;

FIG. 4 illustrates a top view of a wiring structure of a portion of a droplet actuator, which is yet another embodiment of a single-layer wiring structure;

FIG. 5 illustrates a top view of a wiring structure of a portion of a droplet actuator, which is yet another embodiment of a single-layer wiring structure;

FIG. 6 illustrates a top view of a prior art transport electrode of a droplet actuator and illustrates how the electrode wiring may influence a droplet footprint;

FIG. 7 illustrates a top view of a single transport electrode of a droplet actuator, which is one embodiment of an electrode structure for reducing the negative effects of electrostatic interference;

FIG. 8 illustrates a top view of a single transport electrode of a droplet actuator, which is another embodiment of an electrode structure for reducing the negative effects of electrostatic interference;

FIG. 9 illustrates a side view of a segment of a droplet actuator, which is yet another embodiment of an electrode structure for reducing the negative effects of electrostatic interference;

FIG. 10 illustrates a side view of a segment of a droplet actuator, which is yet another embodiment of an electrode structure for reducing the negative effects of electrostatic interference;

FIG. 11 illustrates a side view of a segment of a droplet actuator, which is one embodiment of an electrode structure for improving droplet operations and/or ease of manufacture;

FIG. 12 illustrates a side view of a segment of a droplet actuator, which is another embodiment of an electrode structure for improving droplet operations and/or ease of manufacture;

FIG. 13 illustrates a side view of a segment of a droplet actuator, which is yet another embodiment of an electrode structure for improving droplet operations and/or ease of manufacture and/or assembly;

FIG. 14 illustrates a side view of a segment of a droplet actuator, which is yet another embodiment of an electrode structure for improving droplet operations and/or ease of manufacture and/or assembly;

FIG. 15 illustrates a side view of a segment of a droplet actuator, which is yet another embodiment of an electrode structure for improving droplet operations and/or ease of manufacture; and

FIG. 16 illustrates a side view of a segment of a droplet actuator, which is yet another embodiment of an electrode structure for improving droplet operations.

### DETAILED DESCRIPTION OF THE INVENTION

The invention provides a droplet actuator that has improved wiring and/or electrode structures and methods of making and/or using the droplet actuator. The droplet actuator of the invention exhibits numerous advantages over droplet actuators of the prior art. In various embodiments, the droplet actuator of the invention includes various single-layer wiring configurations for mitigating the constraints and drawbacks that are associated with single-layer designs, such as wireability constraints, limited mechanisms for performing droplet operations, electrostatic interference from wires, and any combinations thereof.

In other embodiments, the droplet actuator of the invention includes a reference electrode that is situated on one substrate that is separated by a gap from a second substrate and one or more control electrodes that are situated on the second substrate. The control electrodes may be placed such that the second substrate is interposed between the control electrodes and the first substrate. Droplet actuators employing the designs of the invention are useful for conducting a variety of droplet operations.

### Example Single-Layer Wire/Electrode Configurations

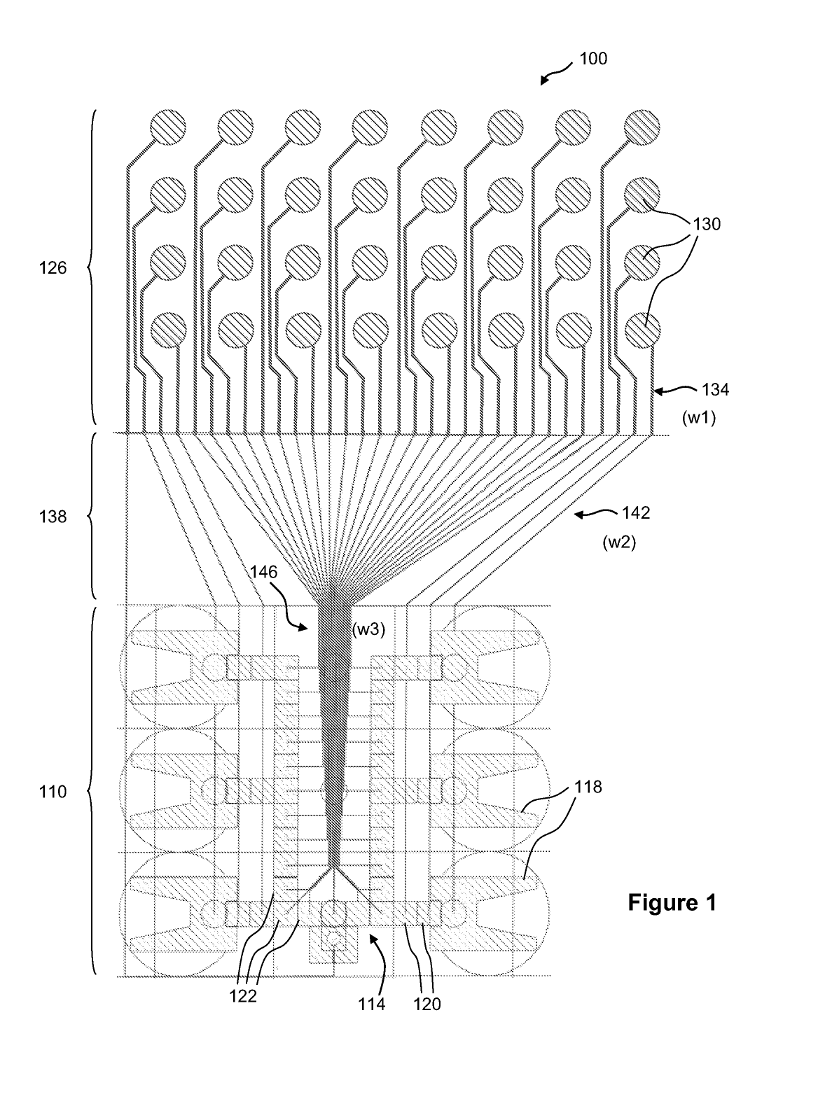

FIG. 1 illustrates a top view of a wiring structure 100 of a portion of a droplet actuator. Wiring structure 100 is provided on a substrate (not shown), which may, for example, be made from any suitably electrically resistant substance, such as a semiconductor chip or a printed circuit board. Wiring structure 100 is one embodiment of a single-layer wiring structure that may, among other things, provide improved wireability. Wiring structure 100 may include a droplet operations region 110. A U-shaped transport bus 114 is disposed within droplet operations region 110. U-shaped transport bus 114 is connected to one or more fluid reservoir electrodes 118 via one or more dispensing electrodes 120 for dispensing droplets (not shown). U-shaped transport bus 114 is formed of multiple transport electrodes 122 for transporting droplets that are dispensed from fluid reservoir electrodes 118, which are arranged around the outer perimeter of U-shaped transport bus 114. In one example, U-shaped transport bus 114 is connected to six fluid reservoir electrodes 118, as shown in FIG. 1.

Wiring structure 100 may further include a contact pad region 126. Multiple control signal contact pads 130 are disposed within contact pad region 126. The multiple control signal contact pads 130 are electrically connected to fluid reservoir electrodes 118 and transport electrodes 122. More specifically, FIG. 1 shows a layout of wire segments 134 that are connected at one end to contact pads 130 and are oriented toward droplet operations region 110 at the opposite end. The layout of wire segments 134 has a certain wiring density. Wire segments 134 have a certain trace width, w1.

Additionally, wiring structure 100 may include a wire region 138 that may translate, in some embodiments, the wiring density of wire segments 134 of contact pad region 126 to a certain greater wiring density of droplet operations region 110. For example, FIG. 1 shows a layout of wire segments 142 that have a certain trace width, w2, and that are a continuation of wire segments 134 of contact pad region 126. More specifically, FIG. 1 shows that one end of wire segments 142 are connected to wire segments 134. In the illustrated embodiment, the opposite end of wire segments 142 are oriented in a tight group toward the center of droplet operations region 110. In particular, a layout of wire segments 146 is disposed within a central area of droplet operations region 110 for connecting to fluid reservoir electrodes 118 and transport electrodes 122. Wire segments 146 have a certain trace width, w3, and are a continuation of wire segments 142 of wire region 138.

The combination of wire segments 134 of contact pad region 126, wire segments 142 of wire region 138, and wire segments 146 of droplet operations region 110 provide a complete electrical connection between contact pads 130 and fluid reservoir electrodes 118 and between contact pads 130 and transport electrodes 122. In order to minimize the electrostatic interference from the wires to the electrodes, the width, w3, of wire segments 146 may be substantially minimized, while the width of the wires may increase as they approach contact pads 130. In one example, the width, w3, of wire segments 146 may be about 10 microns, the width, w2, of wire segments 142 may be about 25 microns, and the width, w1, of wire segments 134 may be about 75 microns.

In the nonlimiting example of FIG. 1, the outermost contact pads 130 are connected to fluid reservoir electrodes 118, which may be bused together, and to dispensing electrodes 120, which may be bused together, while the innermost contact pads 130 are independently connected to transport electrodes 122. The centermost area of U-shaped transport bus 114 provides a clearance region and, therefore, each wire connection for transport electrodes 122 is inside U-shaped transport bus 114. As a result, wiring structure 100 is an example of a single-layer structure that allows easy wiring access to multiple transport electrodes 122 for providing independent control thereof.

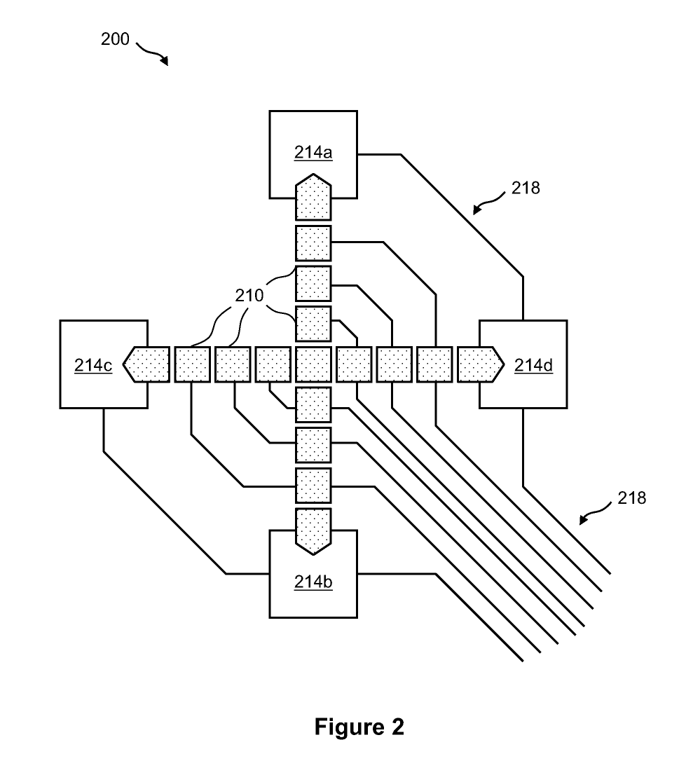

FIG. 2 illustrates a top view of a wiring structure 200 of a portion of a droplet actuator. Wiring structure 200 is another embodiment of a single-layer wiring structure that may, among other things, provide improved wireability. Wiring structure 200 may include multiple transport electrodes 210 for transporting droplets (not shown) that are dispensed from multiple fluid reservoir electrodes 214 (e.g., fluid reservoir electrodes 214a, 214b, 214c, and 214d). In one example, transport electrodes 210 in combination with fluid reservoir electrodes 214 are arranged in a cross pattern, as shown in FIG. 2. By busing multiple electrodes together, wiring structure 200 provides a single-layer design that uses a concentric approach to wiring radial paths of transport electrodes 210 and fluid reservoir electrodes 214. In one example, a set of wires 218 approach transport electrodes 210 and fluid reservoir electrodes 214 from a single entry point and are distributed in a substantially concentric fashion such that certain transport electrodes 210 and fluid reservoir electrodes 214 are bused together, as shown in FIG. 2.

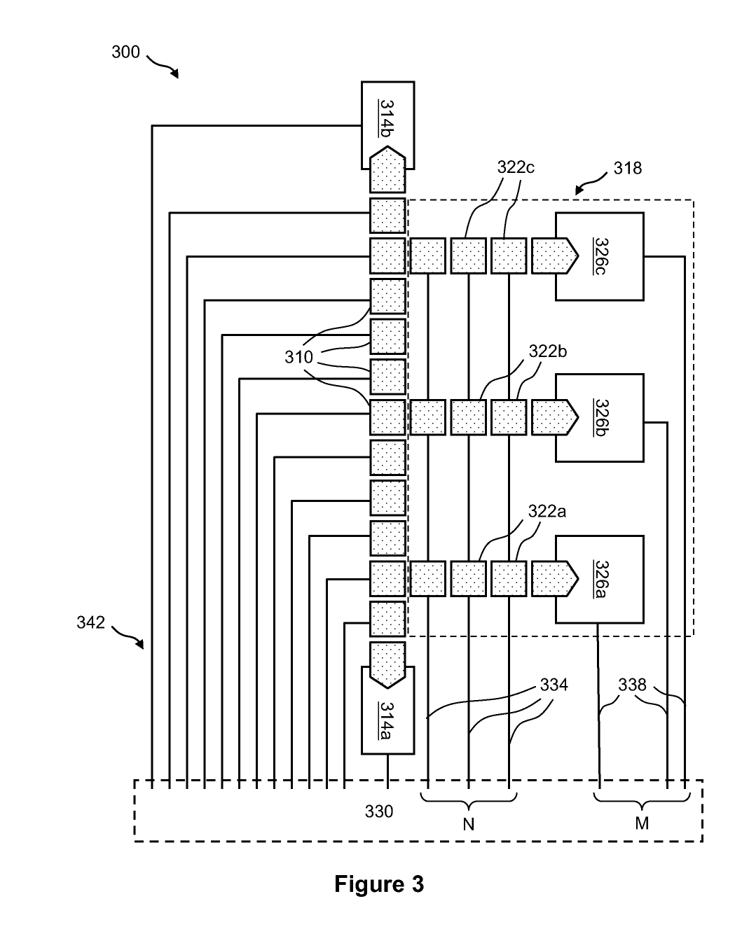

FIG. 3 illustrates a top view of a wiring structure 300 of a portion of a droplet actuator. Wiring structure 300 is yet another embodiment of a single-layer wiring structure that may, among other things, provide improved wireability. Wiring structure 300 may include multiple transport electrodes 310 for transporting droplets (not shown) that are dispensed from multiple fluid reservoir electrodes 314 (e.g., fluid reservoir electrodes 314a and 314b). In one example, transport electrodes 310 are arranged in a line between fluid reservoir electrodes 314a and 314b. Additionally, wiring structure 300 may include a droplet storage array 318. In one example, droplet storage array 318 may include a line of transport electrodes 322a that feeds a fluid reservoir electrode 326a, a line of transport electrodes 322b that feeds a fluid reservoir electrode 326b, and a line of transport electrodes 322c that feeds a fluid reservoir electrode 326c, as shown in FIG. 3.

The single-layer design of wiring structure 300 provides multiple types of electrodes, such as transport electrodes 310, fluid reservoir electrodes 314, and fluid reservoir electrodes 326, that are wired for independent control. For example, a set of wires 338 are provided from contact pad region 330 to individual fluid reservoir electrodes 326a, 326b, and 326c. Additionally, a set of wires 342 is provided from contact pad region 330 to individual transport electrodes 310 and fluid reservoir electrode 314a and 314b, as shown in FIG. 3.

The single-layer design of wiring structure 300 also provides electrodes, such as transport electrodes 322, that are, in the illustrated embodiment, bused together for common control thereof. For example, a contact pad region 330 is shown from which a set of bus wires 334 is provided to transport electrodes 322a, 322b, and 322c, as shown in FIG. 3.

The single-layer design of wiring structure 300 allows the capacity of storage arrays, such as droplet storage array 318, to be maximized based on the number of control signals, such as N×M control signals. In one example, the capacity of the storage array may be N number of wires 334 times M number of wires 338.

### Example Single-Layer Electrostatic Energy Gradient Configurations

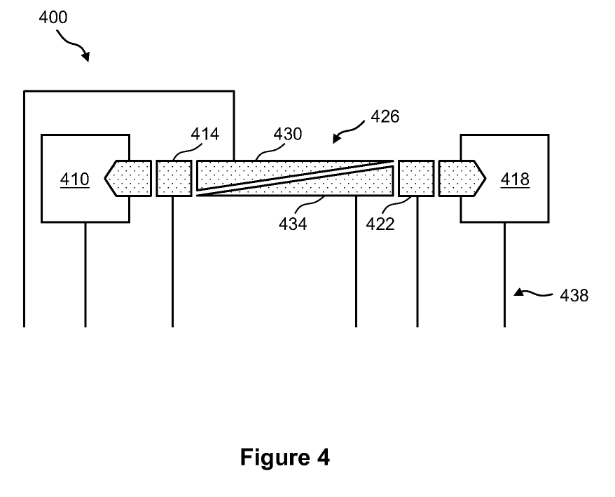

FIG. 4 illustrates a top view of a wiring structure 400 of a portion of a droplet actuator. Wiring structure 400 is one embodiment of a single-layer wiring structure that uses an area gradient to control electrostatic energy for conducting droplet operations. Wiring structure 400 may include a fluid reservoir electrode 410, a transport electrode 414, a fluid reservoir electrode 418, and a transport electrode 422. Arranged between transport electrode 414 and transport electrode 422 is an electrode pair 426 that is formed of a first tapered elongated transport electrode 430 and a second tapered elongated transport electrode 434. More specifically, elongated transport electrode 430 and 434 are each narrow at one end and wide at the other end. The narrow end of elongated transport electrode 430 is oriented adjacent to the wide end of elongated transport electrode 434, as shown in FIG. 4. A set of control wires 438 is provided to all electrodes of wiring structure 400. In particular, electrode pair 426 requires two control wires 438 only, rather than multiple control wires that would be required when using multiple individual transport electrodes to span the same distance as electrode pair 426. As a result, wiring structure 400 provides a single-layer design that minimizes the number of control lines needed to perform droplet operations, while maintaining suitable control of droplet operations.

The area gradient of electrode pair 426 may be used to conduct droplet operations between fluid reservoir electrode 410 and fluid reservoir electrode 418 as follows. In a first example, a droplet (not shown) is transported from fluid reservoir electrode 410 to fluid reservoir electrode 418. Transport electrode 414 is activated and the droplet is dispensed from fluid reservoir electrode 410 to transport electrode 414. In doing so, the droplet at transport electrode 414 overlaps slightly the narrow end of elongated transport electrode 434. Transport electrode 414 is then deactivated and elongated transport electrode 434 is activated. Due to the area gradient along the length of elongated transport electrode 434, the droplet moves from its narrow end to its wide end. Once the droplet is at the wide end of elongated transport electrode 434 and overlapping slightly transport electrode 422, elongated transport electrode 434 is deactivated and transport electrode 422 is activated in order to move the droplet onto transport electrode 422. Transport electrode 422 may then be deactivated and fluid reservoir electrode 418 activated in order to transport the droplet to fluid reservoir electrode 418.

In a second example, the droplet is transported from fluid reservoir electrode 418 to fluid reservoir electrode 410. Transport electrode 422 is activated and the droplet is dispensed from fluid reservoir electrode 418 to transport electrode 422. In doing so, the droplet at transport electrode 422 overlaps slightly the narrow end of elongated transport electrode 430. Transport electrode 422 is then deactivated and elongated transport electrode 430 is activated. Due to the area gradient along the length of elongated transport electrode 430, the droplet moves from its narrow end to its wide end. Once the droplet is at the wide end of elongated transport electrode 430 and overlapping slightly transport electrode 414, elongated transport electrode 430 is deactivated and transport electrode 414 is activated in order to move the droplet onto transport electrode 414. Transport electrode 414 may then be deactivated and fluid reservoir electrode 410 activated in order to transport the droplet to fluid reservoir electrode 410.

Wiring structure 400 is not limited to the geometry of electrode pair 426 for providing an area gradient to control electrostatic energy. Any geometry that provides a continuous area gradient in a certain direction is suitable. For example, other geometries that provide an area gradient may include, but are not limited to, electrodes containing interior voids, such as patterns of circular or square voids that form a density gradient. This density gradient may create an effective electrode area gradient along a certain direction.

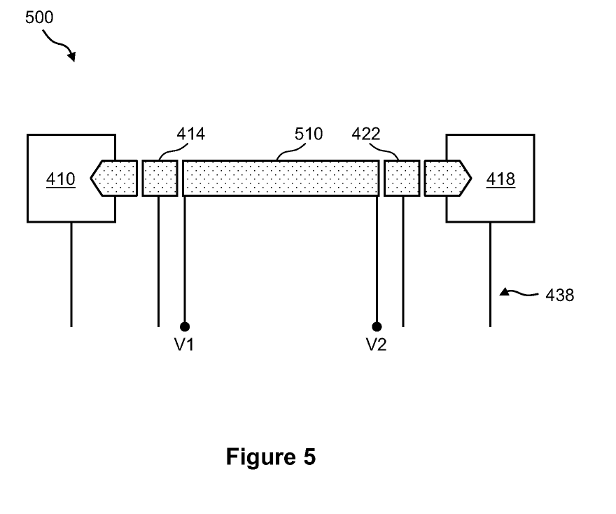

FIG. 5 illustrates a top view of a wiring structure 500 of a portion of a droplet actuator. Wiring structure 500 is one embodiment of a single-layer wiring structure that uses a voltage gradient to control electrostatic energy for conducting droplet operations. Wiring structure 500 is substantially the same as wiring structure 400 of FIG. 4, except that electrode pair 426 of wiring structure 400 is replaced with an elongated transport electrode 510.

Elongated transport electrode 510 has a first voltage control V1 that is connected to one end and a second voltage control V2 that is connected to its opposite end. In this way, a voltage gradient may be developed from one end to the other of elongated transport electrode 510. This voltage gradient is a function of the voltage difference between V1 and V2 and the resistance per unit length R of electrode 510. As a result, wiring structure 500 may reduce the number of control lines that are needed to transport a droplet over a certain distance, while maintaining suitable control of droplet transport operations.

In one example, a droplet (not shown) may be dispensed from fluid reservoir electrode 410 to transport electrode 414. A certain voltage is applied at voltage control V1 and a certain higher voltage is applied at voltage control V2, thereby creating a voltage gradient along elongated transport electrode 510. In one example, the voltage gradient between voltage control V1 and V2 may range from about 0 volts to about 300 volts. Due to the voltage gradient along the length of elongated transport electrode 510, a proportional gradient of electrostatic energy develops along the length of elongated transport electrode 510, which results in the movement of the droplet from the end that is connected to V1 (the lower voltage) to the end that is connected to V2 (the higher voltage). In this way, the droplet may be moved from transport electrode 414 to transport electrode 422, and ultimately to fluid reservoir electrode 418.

Alternatively, a droplet actuator may include a combination of both the electrode area gradient of FIG. 4 and the electrode voltage gradient of FIG. 5 in order to create an electrostatic energy gradient for use as the mechanism for performing droplet operations.

### Example Single-Layer Wire Interference Reducing Configurations

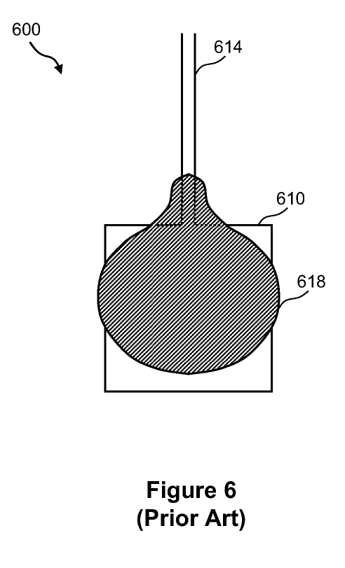

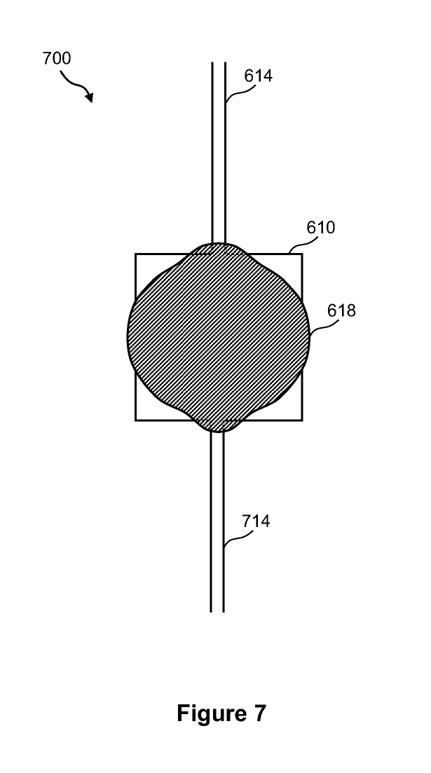

FIG. 6 illustrates a top view of a prior art transport electrode 600 of a droplet actuator. FIG. 6 illustrates how the electrode wiring may influence a droplet footprint. A droplet 618 is disposed upon a transport electrode 610. A control wire 614 provides the control voltage to transport electrode 610. When transport electrode 610 is activated, electrostatic interference from control wire 614 may influence the geometry of droplet 618. Droplet 618 may extend along the path of control wire 614, which distorts its geometry, and may adversely effect droplet operations. FIGS. 7, 8, 9, and 10 illustrate exemplary techniques for reducing, preferably substantially eliminating, the effects of electrostatic interference from wires in a droplet actuator.

FIG. 7 illustrates a top view of a single transport electrode 700 of a droplet actuator. Transport electrode 700 may be substantially the same as transport electrode 600 of FIG. 6, except that transport electrode 700 provides a second control wire 714 that is opposite first control wire 614. Control wire 714, in addition to control wire 614, provides the control voltage to transport electrode 610. As a result, when transport electrode 610 is activated, the electrostatic interference from control wire 714 creates a substantially equal and opposite pull to the electrostatic interference from control wire 614. Consequently, droplet 618 is maintained at substantially the center of transport electrode 610, as shown in FIG. 7, instead of shifting toward control wire 614 in the manner that is illustrated in FIG. 6. Although some droplet distortion may occur, droplet 618 in FIG. 7 remains substantially centered and its symmetry is substantially maintained. The first and second control wires may be independently connected to the same signal contact pad. Alternatively, only one of the two control wires may be connected to the signal contact pad and the remaining control wire may be a wire shaped stub that is connected to the electrode.

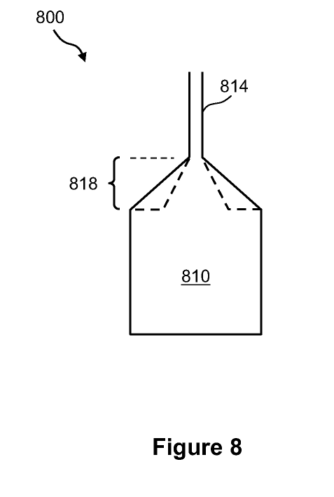

FIG. 8 illustrates a top view of a single transport electrode 800 of a droplet actuator. Transport may include a transport electrode 810 and its associated control wire 814. Transport electrode 800 provides an interface region 818 between transport electrode 810 and wire 814. The metal that forms interface region 818 is tapered from the width of transport electrode 810 to the width of wire 814, as shown in FIG. 8. The height and width of the taper within interface region 818 may vary.

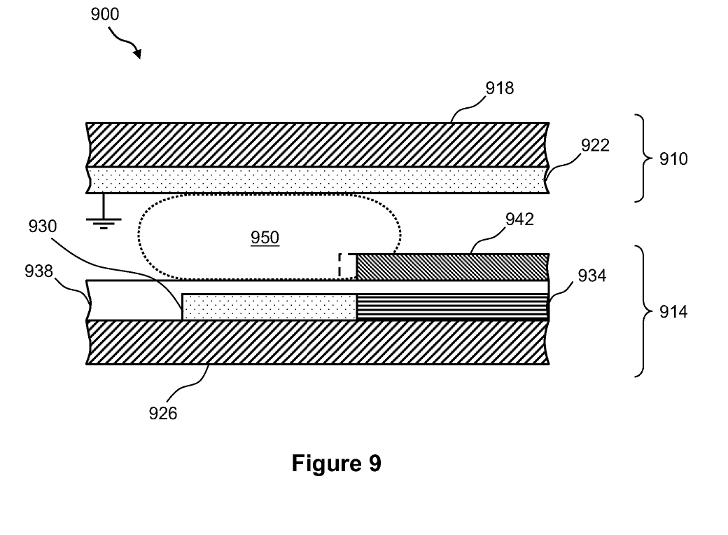

FIG. 9 illustrates a side view of a segment of a droplet actuator 900. Droplet actuator 900 includes yet another embodiment of an electrode structure that may, among other things, reduce the effects of electrostatic interference from wires. Droplet actuator 900 may include a first substrate, such as a top substrate 910, and a second substrate, such as a bottom substrate 914. Top substrate 910 may be formed of substrate 918 and a ground electrode 922. Bottom substrate 914 may be formed of substrate 926 and a transport electrode 930 that has an associated control wire 934. A dielectric layer 938 is typically deposited atop transport electrode 930 and control wire 934. Additionally, an electrically conductive shield 942 is deposited atop dielectric layer 938, as shown in FIG. 9. Shield 942 is substantially aligned with control wire 934. Shield 942 may be formed of any material, such as copper or aluminum, that is suitable for providing electrostatic shielding. Top substrate 910 and bottom substrate 914 are arranged in order to provide a gap therebetween that provides a fluid flow path. In one example, a droplet 950 may be transported along the gap.

The position of shield 942 is such that it provides electrostatic shielding between droplet 950 and control wire 934. The presence of shield 942 reduces, preferably substantially eliminates, the electrostatic attraction between droplet 950 and control wire 934 as compared with the electrostatic attraction between droplet 950 and transport electrode 930. Optionally, shield 942 may overlap transport electrode 930 in order to reduce, preferably substantially eliminate, any fringing fields at the boundary therebetween. The amount of overlap may, in some embodiments, be optimized in order to minimize the reduction in the effective size of transport electrode 930. The embodiment of FIG. 9 uses two layers of metal, but this extra metal layer does not require vias or connections and, thus, the design remains simple. In some embodiments, shield 942 may serve as an electrical connection for controlling the reference potential of the droplet.

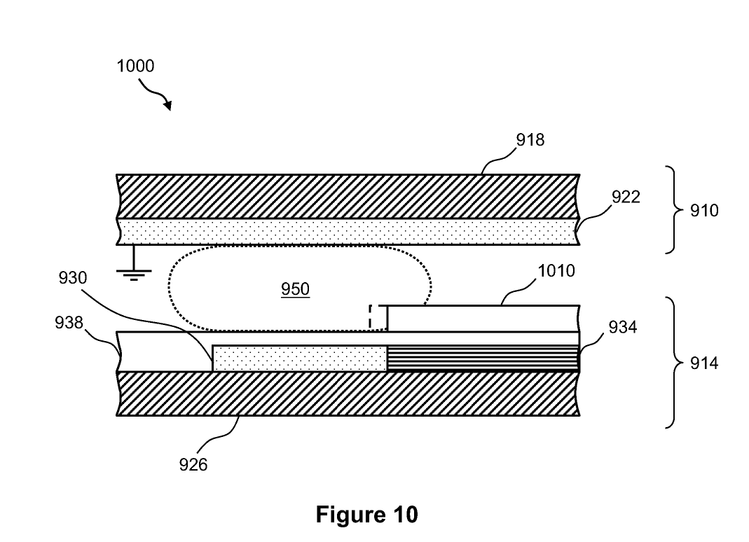

FIG. 10 illustrates a side view of a segment of a droplet actuator 1000. Droplet actuator 1000 includes yet another embodiment of an electrode structure that may, among other things, reduce the effects of electrostatic interference from wires. Droplet actuator 1000 is substantially the same as droplet actuator 900 of FIG. 9, except that the electrostatic shielding (e.g., shield 942) is replaced with another dielectric layer 1010. Again, dielectric layer 1010 is substantially aligned with control wire 934 and is in addition to dielectric layer 938, as shown in FIG. 10. The presence of the additional dielectric layer 1010 reduces, preferably substantially eliminates, the electrostatic attraction between droplet 950 and control wire 934 as compared with the electrostatic attraction between droplet 950 and transport electrode 930.

### Example Electrode Structures for Droplet Actuators

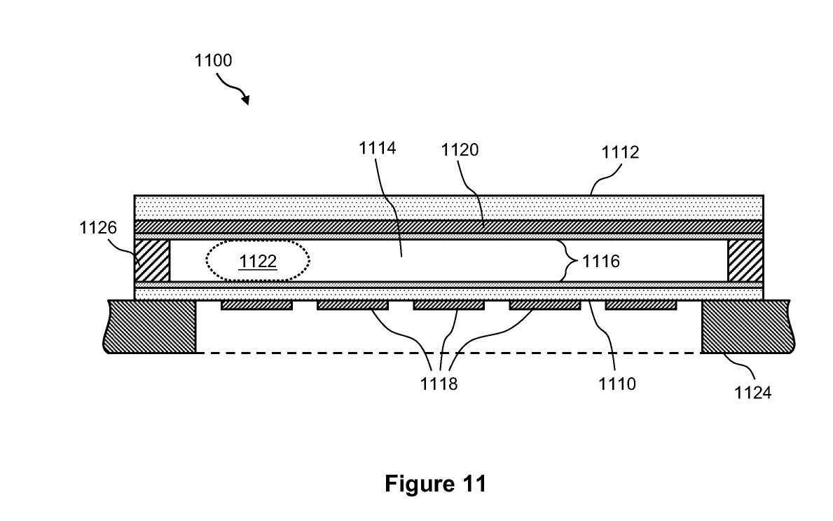

FIG. 11 illustrates a side view of a segment of a droplet actuator 1100. Droplet actuator 1100 may, among other things, provide improved droplet operations and/or ease of manufacture in a droplet actuator. Droplet actuator 1100 may include a first substrate 1110 and a second substrate 1112 that are arranged with a gap 1114 therebetween. A hydrophobic coating 1116 is disposed on an inner surface of first substrate 1110 (i.e., facing gap 1114). One or more control electrodes 1118 are disposed on an outer surface of first substrate 1110 (i.e., facing away from gap 1114). A reference electrode 1120 is disposed on an inner surface of second substrate 1112 (i.e., facing gap 1114). A hydrophobic coating 1116 is disposed on an inner surface of reference electrode 1120 (i.e., facing gap 1114).

First substrate 1110 may, for example, be formed of a thin film of any nonconductive material, such as, but not limited to, Teflon® and Kapton® polyimide film. In one example, the thickness of the thin film material may be from about 1 mil to a few mils. Alternatively, first substrate 1110 may be formed of a thick film of any nonconductive material, such as, but not limited to, glass. In one example, the thickness of the thick film material may be from about 100 microns to about 1 millimeter. In either case, first substrate 1110 must be suitably thin to allow the electric fields of control electrodes 1118 to influence a droplet, such as a droplet 1122, that is to be subjected to droplet operations. Furthermore, the presence of an insulator layer (e.g., first substrate 1110) between control electrodes 1118 and droplet 1122 may require an increase in electrode voltage relative to droplet actuators of the prior art, in order to ensure a suitable electric field at droplet 1122.

Second substrate 1112 may be, for example, a glass substrate. Control electrodes 1118 and reference electrode 1120 may be formed of a conductive material, such as, but not limited to, copper. Alternatively, reference electrode 1120 may be formed of indium tin oxide (ITO). Typically the portion of the substrate on which droplet operations are to take place are made from a hydrophobic material and/or include a hydrophobic coating. The insulating support and hydrophobic coating may be the same material and/or different materials, e.g., an insulating layer with a non-wetting surface. The non-wetting surface may be provided by, for example, but not limited to, a film coating, a chemical surface treatment, physical structures, wettability patterns, a liquid oil layer, and any combinations thereof.

Optionally, an additional support structure may be provided in combination with first substrate 1110, particularly when first substrate 1110 is formed of a thin film material. In one example, a rigid support structure 1124 supports the perimeter of first substrate 1110. For example, rigid support structure 1124 may have an opening in order to accommodate control electrodes 1118 that are on the outer surface of first substrate 1110, as shown in FIG. 11. In one example, support structure 1124 is formed of glass. Optionally, a spacer element 1126 may be provided at the perimeter of droplet actuator 1100 in order to establish the height of gap 1114, as shown in FIG. 11. The spacer element 1126 may serve as a rigid support structure alone or in combination with support structure 1124.

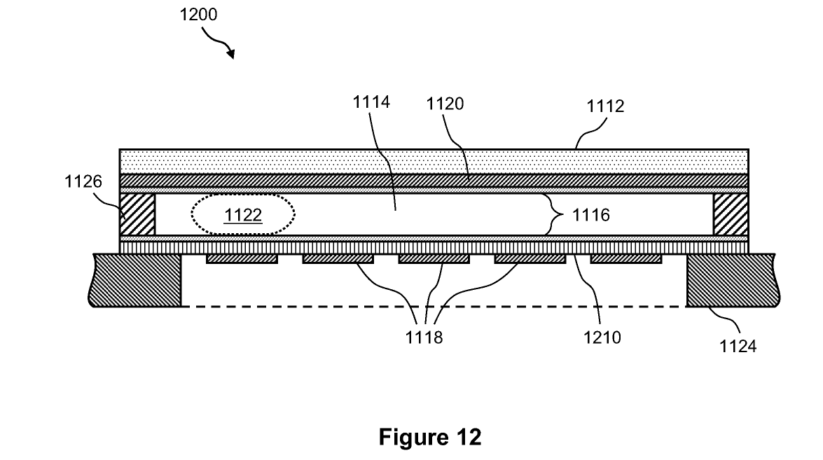

FIG. 12 illustrates a side view of a segment of a droplet actuator 1200. Droplet actuator 1200 may, among other things, provide improved droplet operations and/or ease of manufacture in a droplet actuator. Droplet actuator 1200 is substantially the same as droplet actuator 1100 of FIG. 11, except that first substrate 1110, which is a nonconductive substrate, is replaced with a first substrate 1210, which is a conductive substrate that has anisotropic conductivity. In one example, first substrate 1210 is formed of Z-axis electrically conductive tape, such as 3M™ Anisotropic Conductive Film from 3M Corporation (St. Paul, Minn.). Z-axis tape is formed of an insulator layer within which is embedded multiple parallel wires that are oriented across the thickness of the insulator layer and placed on a certain pitch according to a desired wire density. Z-axis tape is used, for example, in interconnect systems wherein alignment to metal pads, such as control electrodes 1118, is not critical. Conductive substrate 1210 may be used alone or in combination with rigid support structure 1124.

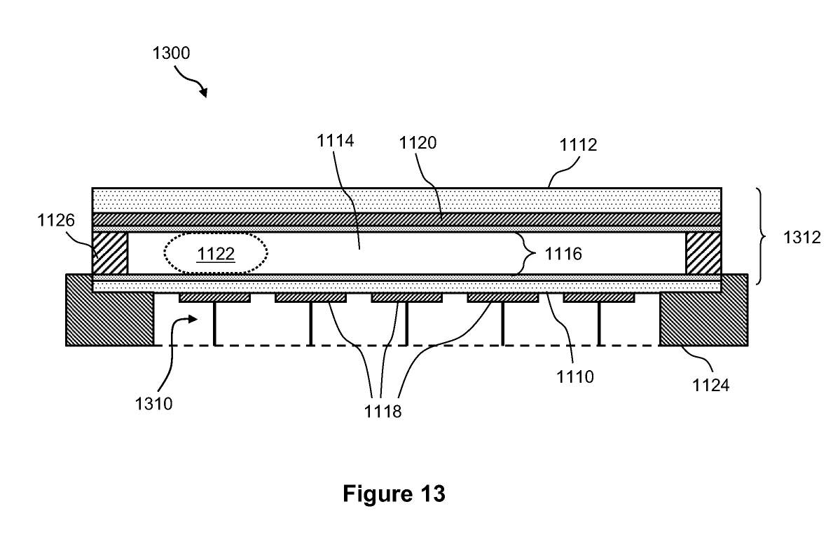

FIG. 13 illustrates a side view of a segment of a droplet actuator 1300. Droplet actuator 1300 may, among other things, provide improved droplet operations and/or ease of manufacture and/or assembly in a droplet actuator. Droplet actuator 1300 is substantially the same as droplet actuator 1100 of FIG. 11 except that droplet actuator 1300 may include further structural support. For example, FIG. 13 shows the inclusion of a bed-of-nails system 1310 upon which control electrodes 1118 may rest in order to provide electrical contact thereto. The arrangement of first substrate 1110 and second substrate 1112 may be in the form of a cartridge 1312 that is separable from bed-of-nails system 1310. Additionally, bed-of-nails system 1310 provides rigid support to cartridge 1312. Cartridge 1312 may include control electrodes 1118 that are permanently disposed upon first substrate 1110. Alternatively, cartridge 1312 may include first substrate 1110 without control electrodes 1118 disposed thereon. More specifically, control electrodes 1118 can be instead incorporated permanently into bed-of-nails system 1310. In this example, a cost savings is realized because control electrodes 1118 are not lost upon disposal of cartridge 1312 and because control electrodes 1118 are not processed in the manufacture of each cartridge 1312. Additionally, in this example, first substrate 1110 may be formed of plastic, which is inexpensive.

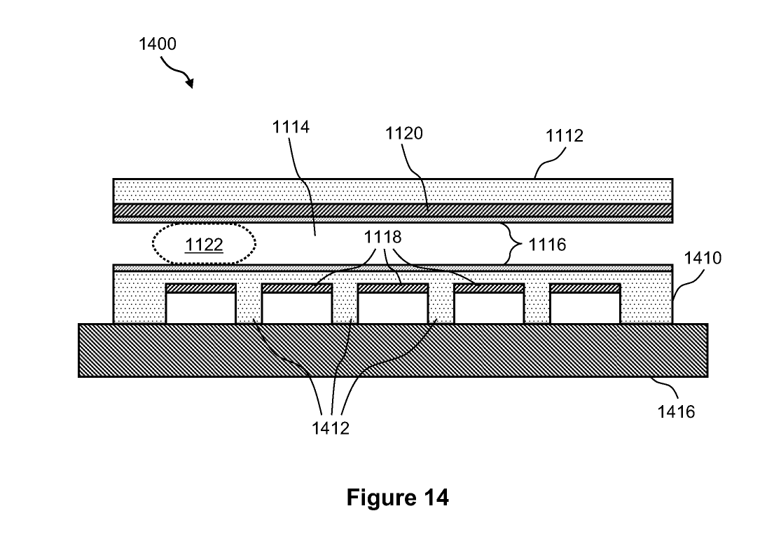

FIG. 14 illustrates a side view of a segment of a droplet actuator 1400. Droplet actuator 1400 may, among other things, provide improved droplet operations and/or ease of manufacture and/or assembly in a droplet actuator. Droplet actuator 1400 is substantially the same as droplet actuator 1100 of FIG. 11 except that first substrate 1110, which is a nonconductive substrate of uniform thickness, is replaced with a first substrate 1410. First substrate 1410 is designed to accommodate control electrodes 1118 on its outer surface and also to provide a structural support mechanism. More specifically, first substrate 1410 may include one or more protrusions 1412 that are located between control electrodes 1118, as shown in FIG. 14. The one or more protrusions 1412 provide additional structural support over and above a substrate of a thin uniform thickness only. First substrate 1410 that has protrusions 1412 may be formed of, for example, a semiconductor material via, for example, a mask and etch process. Protrusions 1412 may be formed using standard semiconductor processes. Protrusions 1412 may rest upon a planar support structure 1416, such as a glass substrate. Protrusions 1412 thus form a waffle-like structure that have arrays or patterns of indentations in which electrodes may be configured.

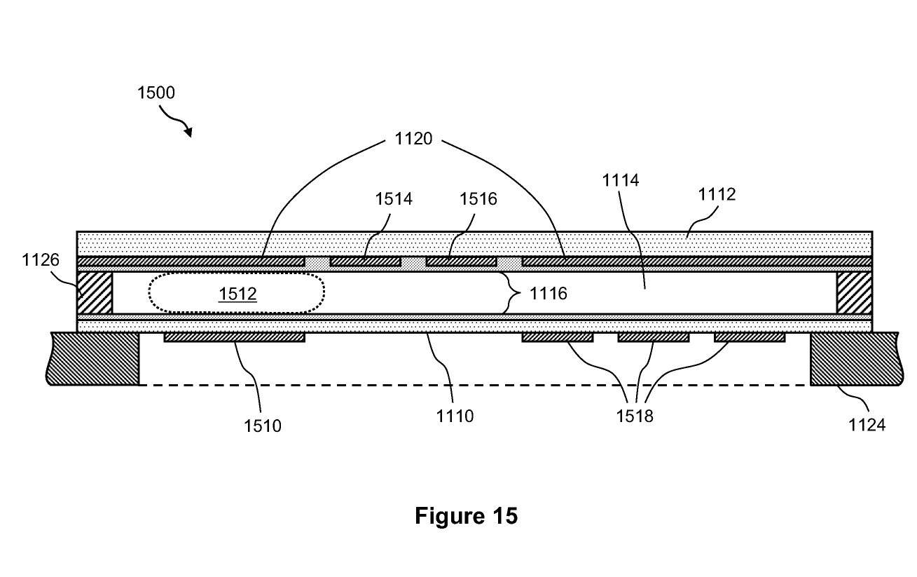

FIG. 15 illustrates a side view of a segment of a droplet actuator 1500. Droplet actuator 1500 may, among other things, provide improved droplet operations and/or ease of manufacture in a droplet actuator. In particular, droplet actuator 1500 may be used for dispensing or metering droplets and for conducting other droplet operations. Droplet actuator 1500 may include a pull-back electrode 1510 that is disposed on the outer surface of first substrate 1110 or otherwise associated with first substrate 1110. Pull-back electrode 1510 may be situated substantially, or in some cases entirely, aligned with a fluid reservoir (not shown). A certain quantity of fluid 1512 may be provided at pull-back electrode 1510. A pinch-off electrode 1514 and a droplet-forming electrode 1516 are disposed on the inner surface of second substrate 1112. Pinch-off electrode 1514 and droplet-forming electrode 1516 are used in metering a droplet to be subjected to droplet operations along one or more transport electrodes 1518, which are disposed on the outer surface of first substrate 1110. A gap in reference electrode 1120, which may be formed by, for example, etching, is formed to accommodate pinch-off electrode 1514 and droplet-forming electrode 1516. Droplet actuator 1500 may include the hydrophobic coating 1116 atop reference electrode 1120, pinch-off electrode 1514, and droplet-forming electrode 1516.

In operation, pinch-off electrode 1514 and droplet-forming electrode 1516 are activated in order to pull a finger of fluid from fluid 1512 at pull-back electrode 1510 onto droplet-forming electrode 1516. Fluid 1512 is grounded via reference electrode 1120 that is opposite pull-back electrode 1510. Once the finger of fluid is formed across pinch-off electrode 1514 and droplet-forming electrode 1516, which are not in the same plane as pull-back electrode 1510, pinch-off electrode 1514 is deactivated and a droplet (not shown) remains on droplet-forming electrode 1516, which is activated. The continued droplet operations of the resulting droplet may be effected using the one or more transport electrodes 1518, which are not in the same plane as pinch-off electrode 1514 and droplet-forming electrode 1516.

Alternatively, a ground electrode may be provided on first substrate 1110, opposite pinch-off electrode 1514 and droplet-forming electrode 1516. Alternatively, pull-back electrode 1510, pinch-off electrode 1514, droplet-forming electrode 1516, and transport electrodes 1518 may be arranged in any combination on any plane.

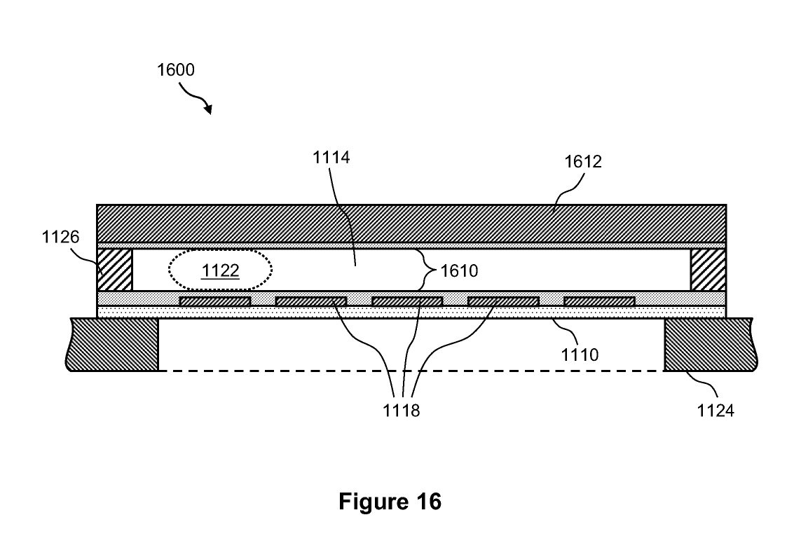

FIG. 16 illustrates a side view of a segment of a droplet actuator 1600. Droplet actuator 1600 may, among other things, provide improved droplet operations in a droplet actuator. In particular, droplet actuator 1600 may be used for conducting droplet operations. Droplet actuator 1600 is substantially the same as droplet actuator 1100 of FIG. 11 except that transport electrodes 1118 are disposed upon the inner surface of first substrate 1110 (i.e., facing gap 1114) and are coated with a hydrophobic dielectric layer 1610. Additionally, second substrate 1112 of FIG. 11, which is substantially nonconductive, is replaced with a second substrate 1612, which is a conductive material, such as, but not limited to, a copper or aluminum foil or plate. Additionally, second substrate 1612 is coated with a hydrophobic dielectric layer 1610. Alternatively, transport electrodes 1118 may be disposed on the outer surface of first substrate 1110, as shown in FIG. 11. One or more observation openings may be provided in the foil in order to allow observation of a droplet on the droplet actuator and/or sensing of a property of a droplet on a droplet actuator.

### Droplet Actuator

For examples of droplet actuator architectures that are suitable for use with the present invention, see U.S. Pat. No. 6,911,132, entitled, “Apparatus for Manipulating Droplets by Electrowetting-Based Techniques,” issued on Jun. 28, 2005 to Pamula et al.; U.S. patent application Ser. No. 11/343,284, entitled, “Apparatuses and Methods for Manipulating Droplets on a Printed Circuit Board,” filed on filed on Jan. 30, 2006; U.S. Pat. Nos. 6,773,566, entitled, “Electrostatic Actuators for Microfluidics and Methods for Using Same,” issued on Aug. 10, 2004 and 6,565,727, entitled, “Actuators for Microfluidics Without Moving Parts,” issued on Jan. 24, 2000, both to Shenderov et al.; and Pollack et al., International Patent Application No. PCT/US 06/47486, entitled, “Droplet-Based Biochemistry,” filed on Dec. 11, 2006, the disclosures of which are incorporated herein by reference.

### Fluids

For examples of fluids that may be subjected to droplet operations using the approach of the invention, see the patents listed in section 8.5, especially International Patent Application No. PCT/US 06/47486, entitled, “Droplet-Based Biochemistry,” filed on Dec. 11, 2006. In some embodiments, the fluid includes a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, fluidized tissues, fluidized organisms, biological swabs and biological washes. In some embodiment, the fluid includes a reagent, such as water, deionized water, saline solutions, acidic solutions, basic solutions, detergent solutions and/or buffers. In some embodiments, the fluid includes a reagent, such as a reagent for a biochemical protocol, such as a nucleic acid amplification protocol, an affinity-based assay protocol, a sequencing protocol, and/or a protocol for analyses of biological fluids.

### Filler Fluids

The gap is typically filled with a filler fluid. The filler fluid may, for example, be a low-viscosity oil, such as silicone oil. Other examples of filler fluids are provided in International Patent Application No. PCT/US 06/47486, entitled, “Droplet-Based Biochemistry,” filed on Dec. 11, 2006.

### Method of Providing Improved Single-Layer Microactuator Structures

Referring to FIGS. 1 through 10, one approach for providing improved single metal layer designs for droplet microactuators may include, but is not limited to, the steps of (1) providing mechanisms for improved wireability, such as providing certain electrode configurations with improved wiring accessibility, radial wiring, and bus wiring; (2) creating electrostatic energy gradients as the droplet manipulation mechanism, such as providing an electrode area gradient and/or an electrode voltage gradient; and (3) reducing electrostatic interference from the electrode wires to the droplet, such as by providing electrostatic shielding.

### Method of Providing a Bi-Planar Droplet Actuator Structure

Referring to FIGS. 11 through 16, one approach for providing a structure for a droplet actuator may include, but is not limited to, the steps of (1) providing a first multilayer plate that is formed, for example, of a first nonconductive substrate having a hydrophobic coating on one surface and an arrangement of conductive transport electrodes on its opposite surface; (2) providing a second multilayer plate that is formed, for example, of a second nonconductive substrate, where a conductive reference electrode is disposed atop the second nonconductive substrate and where a hydrophobic coating is disposed atop the ground electrode; (3) arranging the first and second multilayer plates with a gap therebetween such that the hydrophobic coating and the transport electrodes of the first plate are facing toward and away from the gap, respectively, and such that the hydrophobic coating of the second plate is facing toward the gap; and (4) optionally providing additional structural support mechanisms.

### Concluding Remarks

The foregoing detailed description of embodiments refers to the accompanying drawings, which illustrate specific embodiments of the invention. Other embodiments having different structures and operations do not depart from the scope of the present invention.

This specification is divided into sections for the convenience of the reader only. Headings should not be construed as limiting of the scope of the invention.

It will be understood that various details of the present invention may be changed without departing from the scope of the present invention. Furthermore, the foregoing description is for the purpose of illustration only, and not for the purpose of limitation, as the present invention is defined by the claims as set forth hereinafter.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. An apparatus for manipulating droplets, the apparatus comprising:
(a) a substrate comprising a surface;
(b) a transport electrode disposed on the substrate surface and configured to impart a gradient force to a droplet, wherein the gradient force is sufficient to manipulate the droplet; and
(c) a plurality of wires for providing power to the transport electrode, wherein the substrate, transport electrode and plurality of wires comprise a single-layer of a droplet actuator.

18. The apparatus according to claim 17 wherein the transport electrode includes an elongated portion.

19. The apparatus according to claim 17 wherein the plurality of wires consist of two wires.

20. The apparatus according to claim 17 wherein the plurality of wires selectively provide power from a source to the transport electrode.

21. The apparatus according to claim 17 further comprising another transport electrode proximate the transport electrode and configured to urge the droplet at least one of away and towards the transport electrode.

22. The apparatus according to claim 17 wherein the gradient force comprises an area gradient force along a direction.

23. The apparatus according to claim 22 wherein the transport electrode includes an interior void.

24. The apparatus according to claim 22 wherein the transport electrode includes a tapered portion comprising a wide end and a narrow end.

25. The apparatus according to claim 24 wherein the area gradient force causes the droplet to move from the narrow end to the wide end.

26. The apparatus according to claim 24 further comprising another transport electrode, wherein the other transport electrode includes a tapered portion comprising a wide end and a narrow end, and wherein the wide end of the transport electrode is adjacent the narrow end of the other transport electrode.

27. The apparatus according to claim 24 further comprising another transport electrode, wherein the other transport electrode includes a tapered portion comprising a wide end and a narrow end, and wherein the narrow end of the transport electrode is adjacent the wide end of the other transport electrode.

28. The apparatus according to claim 17 wherein the gradient force comprises a voltage gradient force.

29. The apparatus according to claim 28 wherein the transport electrode is connected to a first and second voltage controls having different voltage magnitudes.

30. The apparatus according to claim 28 wherein the voltage gradient force ranges in magnitude from about 0 volts to about 300 volts.

31. An apparatus for manipulating a droplet, the apparatus comprising:
(a) a substrate comprising a surface;
(b) a transport electrode disposed on the substrate surface;
(c) a wire connected to and configured to deliver power to the transport electrode, wherein the wire produces electrostatic interference; and
(d) an electrostatic interference reducing structure configured to minimize the electrostatic interference affecting the droplet wherein the substrate, transport electrode, wire and electrostatic interference reducing structure comprise a single-layer of a droplet actuator.

32. The apparatus according to claim 31 wherein the electrostatic interference reducing structure comprises another wire connected to an opposite side the transport electrode than is the wire connected.

33. The apparatus according to claim 32 wherein the other wire is connected to a control pad.

34. The apparatus according to claim 32 wherein the other wire is not connected to a control pad.

35. The apparatus according to claim 31 wherein the electrostatic interference reducing structure comprises a metal interface region between the transport electrode and the wire.

36. The apparatus according to claim 35 wherein the electrostatic interference reducing structure is tapered.

37. The apparatus according to claim 31 wherein the electrostatic interference reducing structure comprises an electrostatic shield.

38. The apparatus according to claim 37 wherein the electrostatic shield substantially aligns with the wire.

39. The apparatus according to claim 37 wherein the electrostatic shield is positioned above the wire relative to the substrate surface.

40. The apparatus according to claim 37 further comprising a dielectric layer positioned above the wire and below the electrostatic shield relative to the substrate surface.

41. The apparatus according to claim 37 wherein the electrostatic shield comprises metal.

42. The apparatus according to claim 37 wherein the electrostatic shield comprises a dielectric material.

43. (canceled)

44. (canceled)

45. (canceled)

46. A droplet actuator comprising:
(a) first and second substrates separated to form a gap, the first substrate comprising an inner surface facing the gap and an outer surface facing away from the gap; and
(b) electrodes on the outer surface of the first substrate arranged for conducting droplet operations.

47. The droplet actuator of claim 46 wherein the first substrate comprises a thin sheet or thin film.

48. The droplet actuator of claim 46 wherein the first substrate has a thickness ranging from 10 microns to 1 mm.

49. The droplet actuator of claim 46 wherein the first substrate comprises a glass substrate.

50. The droplet actuator of claim 46 wherein the first substrate comprises a silicon substrate.

51. The droplet actuator of claim 46 wherein the first substrate comprises an anisotropic conductive element arranged to conduct from the electrode across the first substrate.

52. The droplet actuator of claim 46 wherein the first and second substrates comprise solid supports.

53. (canceled)

54. (canceled)

55. A droplet actuator device comprising:
(a) a substrate comprising a droplet operations surface; and
(b) a device comprising electrodes arranged for conducting droplet operations and arranged to accept the substrate in a manner which brings the electrodes into contact with or into sufficient proximity to the droplet operations surface that the electrodes can mediate droplet operations in the gap.

56. (canceled)

57. (canceled)

58. (canceled)

59. (canceled)
